(19) United States
(12) Patent Application Publication
(10) Pub. No.: US 2026/0129541 A1
(43) Pub. Date: May 7, 2026

(54) METHOD AND APPARATUS FOR USING CONDITION AND NON-CONDITION DURING LOWER-LAYER TRIGGERED MOBILITY OF TERMINAL IN WIRELESS COMMUNICATION SYSTEMS

(71) Applicant: Samsung Electronics Co., Ltd., Gyeonggi-do (KR)

(72) Inventors: June HWANG, Gyeonggi-do (KR); Seungri JIN, Gyeonggi-do (KR)

(21) Appl. No.: 19/381,705

(22) Filed: Nov. 6, 2025

(30) Foreign Application Priority Data
Nov. 6, 2024 (KR) 10-2024-0156335

(51) Int. Cl. H04W 36/32; H04W 36/00

(52) U.S. Cl. CPC H04W 36/324; H04W 36/0085

(57) ABSTRACT

The disclosure relates to a 5G or 6G communication system for supporting a higher data transmission rate. A method performed by a UE in a wireless communication system may include receiving, from a base station, configuration information on an LTM including an execution condition for an LTM cell switch; and performing an evaluation for the execution condition of the LTM cell switch based on the configuration information, after the LTM cell switch.

### CROSS-REFERENCE TO RELATED APPLICATION(S)

This application is based on and claims priority under 35 U.S.C. 119 to Korean Patent Application No. 10-2024-0156335, which was filed in the Korean Intellectual Property Office on Nov. 6, 2024, the entire disclosure of which is incorporated herein by reference.

### BACKGROUND

### 1. FIELD

The disclosure relates generally to an operation of a user equipment (UE) in a wireless (or mobile) communication system, and more specifically, to the use of a condition and a non-condition during mobility of a UE.

### 2. DESCRIPTION OF RELATED ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

When a lower-layer triggered mobility method is used for a UE's movement, the UE may autonomously move by using a condition. An aspect the disclosure is to provide a method and a device for configuring such a condition.

Another aspect of the disclosure is to provide a method and apparatus to use a condition and a non-condition during mobility of a UE.

Another aspect of the disclosure is to provide a UE that may perform a conditional movement without a separate signal from a network in a movement in a current cell and a subsequent movement through a specific beam-based event.

In accordance with an aspect of the disclosure, a method is provided for a UE in a wireless communication system. The method includes receiving, from a base station, configuration information on an L1/L2 triggered mobility (LTM) including an execution condition for an LTM cell switch; and performing an evaluation for the execution condition of the LTM cell switch based on the configuration information, after the LTM cell switch.

In accordance with another aspect of the disclosure, a method is provided for a base station in a wireless communication system. The method includes transmitting, to a UE, configuration information on an LTM including an execution condition for an LTM cell switch, wherein an evaluation for the execution condition of the LTM cell switch is based on the configuration information after the LTM cell switch.

In accordance with another aspect of the disclosure, a UE is provided, which includes a transceiver; a processor; and a memory storing instructions executable by the processor, individually or in any combination, to cause the UE to receive, from a base station, configuration information on an LTM including an execution condition for an LTM cell switch, and perform an evaluation for the execution condition of the LTM cell switch based on the configuration information after the LTM cell switch.

In accordance with another aspect of the disclosure, a base station is provided, which includes a transceiver; a processor; and a memory storing instructions executable by the processor, individually or in any combination, to cause the base station to transmit, to a UE, configuration information on an LTM including an execution condition for an LTM cell switch, wherein an evaluation for the execution condition of the LTM cell switch is based on the configuration information after the LTM cell switch.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a long term evolution (LTE) system according to an embodiment;

FIG. 2 illustrates a radio protocol structure of an LTE system according to an embodiment;

FIG. 3 illustrates a next-generation mobile communication system according to an embodiment;

FIG. 4 illustrates a radio protocol structure of a next-generation mobile communication system according to an embodiment;

FIG. 5 illustrates a UE according to an embodiment;

FIG. 6 illustrates an NR base station according to an embodiment;

FIG. 7 illustrates an example of an initial condition and a subsequent execution condition being indicated together in a condition L1/2 triggered mobility (CLTM) target cell configuration in a wireless communication system according to an embodiment;

FIG. 8 illustrates an example of an initial condition and a subsequent execution condition being included in an LTM-CSI-ReportConfig in a wireless communication system according to an embodiment;

FIG. 9 illustrates movement between a CLTM cell and an L1/2 triggered mobility (LTM) cell in a wireless communication system according to an embodiment;

FIG. 10 is a signal flow diagram illustrating a deactivation/suspension operation performed with a centralized unit (CU) identifier (ID) in a wireless communication system according to an embodiment;

FIG. 11 is a signal flow diagram illustrating a deactivation/suspension operation performed by a network indication in a wireless communication system according to an embodiment; and

FIG. 12 is a signal flow diagram illustrating use of a CLTM candidate ID and/or whether CLTM condition information exists in a wireless communication system according to an embodiment.

### DETAILED DESCRIPTION

Hereinafter, embodiments of the disclosure will be described with reference to the accompanying drawings. In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Also, the size of each element may not completely reflect the actual size thereof. In the respective drawings, the same or corresponding elements may be assigned the same or similar reference numerals.

Various advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” may refer to a software element or a hardware element, such as a field programmable gate array (FPGA) or an application specific integrated circuit (ASIC), and the “unit” may perform certain functions. However, “unit” does not always have a meaning limited to software or hardware. For example, a “unit” may be constructed either to be stored in an addressable storage medium or to execute one or more processors. Therefore, “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the term “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

Although the following detailed description of embodiments of the disclosure is mainly directed to NR as a radio access network and packet core (5G system or 5G core network (CN) or next generation core (NG Core)) as a CN in the 5G mobile communication standards specified by the 3rd generation partnership project (3GPP) that is a mobile communication standardization group, based on determinations by those skilled in the art, embodiments of the disclosure may be applied to other communication systems having similar backgrounds through some modifications without significantly departing from the scope of the disclosure.

In the following description, some of terms and names defined in the 3GPP standards (e.g., standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a wireless access unit, a base station controller, and a node on a network. A terminal may include a UE, a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (i.e., a 5G mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and Internet of things (IoT)-related technology. In the disclosure, the term “eNB” may be interchangeably used with the term “gNB” for the sake of descriptive convenience. That is, a base station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, etc., as well as typical voice-based services.

As an example of a broadband wireless communication system, an LTE system employs an orthogonal frequency division multiplexing (OFDM) scheme in a downlink (DL) and employs a single carrier frequency division multiple access (SC-FDMA) scheme in an uplink (UL). Herein, UL refers to a radio link via which a UE or an MS transmits data or control signals to a base station (BS) (or eNode B), and DL refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, should reflect various requirements of users, service providers, and the like, services satisfying various requirements should be supported. The services considered in the 5G communication system include eMBB communication, mMTC, URLLC, etc.

According to some embodiments, eMBB may aim at providing a data rate higher than that supported by existing LTE, LTE-A, or LTE-Pro. For example, in the 5G communication system, eMBB should provide a peak data rate of 20 Gbps in the DL and a peak data rate of 10 Gbps in the UL for a single base station. Furthermore, the 5G communication system should provide an increased user-perceived data rate to the UE, as well as the maximum data rate. In order to satisfy such requirements, transmission/reception technologies including a further enhanced MIMO transmission technique may need to be improved. Also, the data rate required for the 5G communication system may be obtained using a frequency bandwidth more than 20 MHz in a frequency band of 3 to 6 GHz or 6 GHz or above, instead of transmitting signals using a transmission bandwidth up to 20 MHz in a band of 2GHz used in LTE.

In addition, mMTC is being considered to support application services such as IoT in the 5G communication system. mMTC may have requirements, such as support of connection of a large number of UEs in a cell, enhancement coverage of UEs, improved battery time, a reduction in the cost of a UE, etc., in order to effectively provide the IoT. Since the IoT provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC should be configured to be inexpensive, and may require a very long battery life-time such as 10 to 15 years because it is difficult to frequently replace the battery of the UE.

URLLC, which is a cellular-based mission-critical wireless communication service, may be used for remote control for robots or machines, industrial automation, unmanned aerial vehicles, remote health care, emergency alert, etc. Thus, URLLC should provide communication with ultra-low latency and ultra-high reliability. For example, a service supporting URLLC should satisfy an air interface latency of less than 0.5 ms, and may also require a packet error rate of 10⁻⁵ or less. Therefore, for the services supporting URLLC, a 5G system must provide a transmit time interval (TTI) shorter than those of other services, and may also require a design for assigning a large number of resources in a frequency band in order to secure reliability of a communication link.

The above-described three services considered in the 5G communication system, i.e., eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely examples of different types of services, and service types to which the disclosure is applied are not limited to the above examples. In an embodiment of the disclosure, a master node (MN) may be construed as a master base station, and a secondary node (SN) may be construed as a secondary base station. Further, in an embodiment of the disclosure, an MN and an SN may be different base stations or base stations using different radio access technologies (RATs), and may be base stations using the same RAT in some cases. An MN and an SN may be distinguished by using general expressions, such as a first base station and a second base station.

In an embodiment of the disclosure, a radio resource control (RRC) message transmitted by an MN may be referred to as an MN RRC message. An RRC message generated by an SN may be referred to as an SN RRC message.

An intra-SN conditional primary secondary cell (PSCell) change (CPC) in Release 16 is initiated by an SN, in which a configuration of a candidate target PSCell is transmitted to a UE through an RRC message of the SN. However, an inter-SN conditional PSCell change in Release 17 is initiated by an MN or SN, in which a configuration of a candidate target PSCell is transmitted to a UE through an RRC message of the MN. When a network wants to configure both Rel-16 intra-SN conditional PSCell change and Rel-17 inter-SN conditional PSCell change for a UE, the UE's candidate target PSCell configuration, measurement, and condition evaluation may be performed in a unit of a specific number of candidate PSCells. Therefore, an MN and an SN should negotiate a maximum number of conditional PSCell change configurations that each thereof is responsible for, and thus the number of conditional PSCell change configurations and measurement values operable according to the capability of the UE may not be exceeded.

Further, when transmitting a conditional PSCell change configuration to the UE, an ID indicating each candidate target PSCell configuration is allocated by the SN in a case of an intra-SN, and is allocated by the MN in a case of an inter-SN. When all candidate PSCell change configurations are stored in a single storage, i.e., a variable, entities to allocate IDs are different, and thus a collision may occur between the IDs.

In addition, when the foregoing two conditional PSCell changes are configured and operated for the UE, when the intra-SN CPC is successfully performed, the inter-SN CPC configuration may be deleted according to a specific condition.

According to embodiments of the disclosure, it is possible to prevent a UE from performing an operation beyond a UE capability according to CPC configurations of an MN and an SN. Further, it is also possible to prevent an error caused by ID duplication between a plurality of CPC configurations. In addition, an inter-SN CPC configuration may be efficiently managed according to execution of an intra-SN CPC.

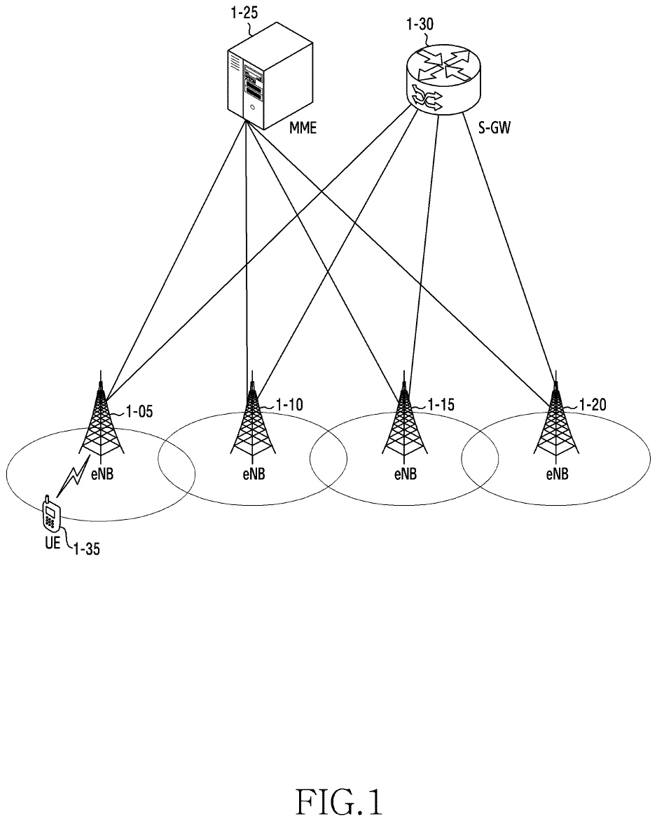

FIG. 1 illustrates an LTE system according to an embodiment.

Referring to FIG. 1, a radio access network of an LTE system may include next-generation base stations (e.g., evolved Node Bs (ENBs), Node Bs, or base stations) 1-05, 1-10, 1-15, and 1-20, a mobility management entity (MME) 1-25, and a serving gateway (S-GW) 1-30. A UE or terminal 1-35 may access an external network through the ENBs 1-05 to 1-20 and the S-GW 1-30.

In FIG. 1, the ENBs 1-05 to 1-20 may correspond to conventional node Bs of a universal mobile telecommunication system (UMTS). The ENBs may be connected to the UE 1-35 through a radio channel, and perform more complicated roles than the conventional Node Bs. In the LTE system, since user traffic including real-time services, such as voice over Internet protocol (VoIP), may be serviced through a shared channel, a device that collects state information, such as buffer states, available transmit power states, and channel states of UEs, and performs scheduling accordingly is required, and the ENBs 1-05 to 1-20 may serve as the device. In general, one ENB may control multiple cells. For example, in order to implement a transfer rate of 100 Mbps, the LTE system may use OFDM as a RAT in a bandwidth of, for example, 20 MHz. The examples given above are not limiting.

Furthermore, the ENBs 1-05 to 1-20 may employ an adaptive modulation and coding (AMC) scheme for determining a modulation scheme and a channel coding rate according to a channel state of the UE 1-35. The S-GW 1-30 is a device that provides a data bearer, and may generate or remove a data bearer under the control of the MME 1-25. The MME 1-25 is a device responsible for various control functions as well as a mobility management function for the UE 1-35, and may be connected to the multiple base stations 1-05 to 1-20.

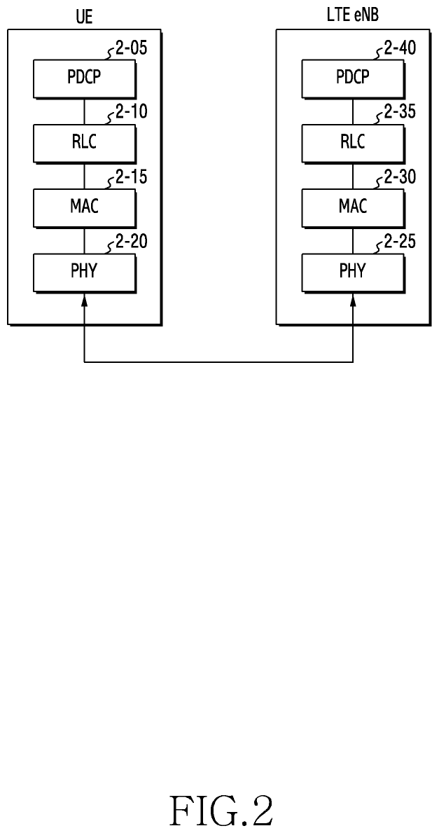

FIG. 2 illustrates a radio protocol structure of an LTE system according to an embodiment.

Referring to FIG. 2, a radio protocol of the LTE system may include a packet data convergence protocol (PDCP) 2-05 or 2-40, a radio link control (RLC) 2-10 or 2-35, a medium access control (MAC) 2-15 or 2-30, and a physical layer (PHY) 2-20 or 2-25 on each of UE and ENB sides. The radio protocol of the LTE system may also include a larger or smaller number of layers than the structure illustrated in FIG. 2.

According to an embodiment of the disclosure, the PDCP 2-05 or 2-40 may serve to perform operations, such as IP header compression/reconstruction. Example functions of the PDCP 2-05 or 2-40 may include:
Header compression and decompression: robust header compression (ROHC) only
Transfer of user data
In-sequence delivery of upper layer protocol data units (PDUs) at a PDCP re-establishment procedure for RLC acknowledged model (AM)
For split bearers in dual connectivity (DC) (e.g., only support for RLC AM): PDCP PDU routing for transmission and PDCP PDU reordering for reception
Duplicate detection of lower layer service data units (SDUs) at PDCP re-establishment procedure for RLC AM -Retransmission of PDCP SDUs at handover and, for split bearers in DC, of PDCP PDUs at PDCP data-recovery procedure, for RLC AM
Ciphering and deciphering
Timer-based SDU discard in UL

According to an embodiment of the disclosure, the RLC 2-10 or 2-35 may reconfigure a PDCP PDU into appropriate sizes to perform an automatic repeat request (ARQ) operation. Example functions of the RLC 2-10 or 2-35 may include:
Transfer of upper layer PDUs
Error Correction through ARQ (only for acknowledged mode (AM) data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

According to an embodiment of the disclosure, the MAC 2-15 or 2-30 may be connected to several RLC layer devices configured in a single UE, and multiplex RLC PDUs to a MAC PDU and demultiplex RLC PDUs from an MAC PDU. Example functions of the MAC 2-15 or 2-30 may include:
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast multicast service (MBMS) service identification
Transport format selection
Padding

According to an embodiment of the disclosure, the physical layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

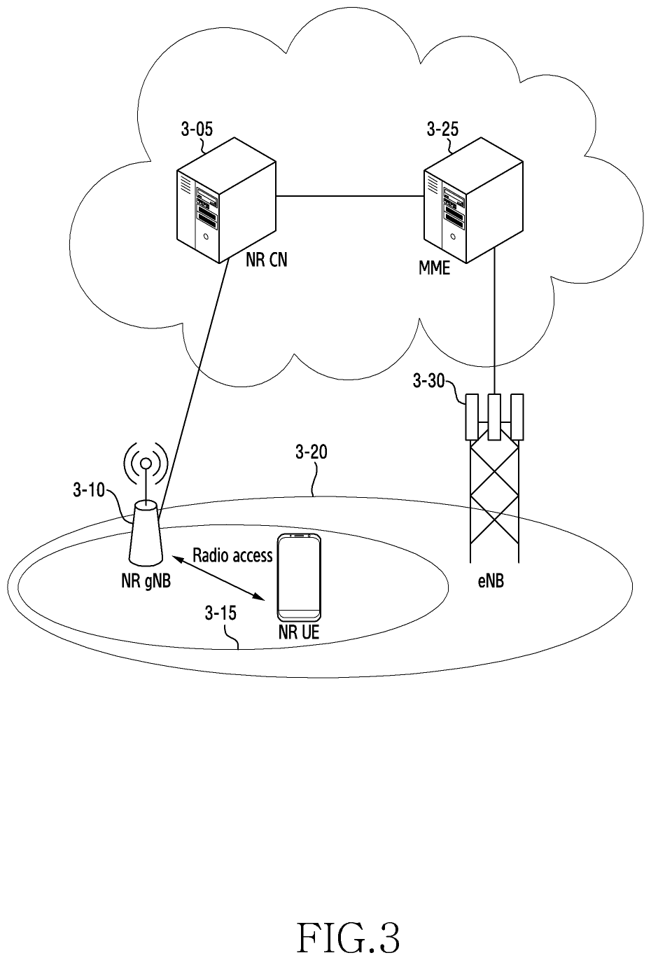

FIG. 3 illustrates a next-generation mobile communication system according to an embodiment.

Referring to FIG. 3, a radio access network of a wireless communication system (e.g., NR or 5G) may include a new radio node B (NR gNB or NR base station) 3-10, and an NR CN 3-05. A new radio UE (NR UE or NR terminal) 3-15 may access an external network via the NR gNB 3-10 and the NR CN 3-05.

In FIG. 3, the NR gNB 3-10 may correspond to an eNB of an LTE system. The NR gNB may be connected to the NR UE 3-15 through a radio channel and provide outstanding services as compared to a conventional node B. In the next-generation mobile communication system, since all user traffic may be serviced through a shared channel, a device that collects state information, such as buffer states, available transmit power states, and channel states of UEs, and performs scheduling accordingly is required, and the NR gNB 3-10 may serve as the device. One NR gNB may control multiple cells.

According to an embodiment of the disclosure, in order to implement ultrahigh-speed data transfer beyond the current LTE, the next-generation mobile communication system may provide a wider bandwidth than the existing maximum bandwidth. In addition, the next-generation mobile communication system may employ an OFDM as a RAT, and additionally use a beamforming technology.

Furthermore, according to an embodiment of the disclosure, the next-generation mobile communication system may employ an AMC scheme for determining a modulation scheme and a channel coding rate according to a channel state of a UE. The NR CN 3-05 may perform functions such as mobility support, bearer configuration, and quality of service (QoS) configuration. The NR CN 3-05 is a device responsible for various control functions as well as a mobility management function for a UE, and may be connected to multiple base stations. In addition, the next-generation mobile communication system may interwork with the existing LTE system, and the NR CN 3-05 may be connected to an MME 3-25 via a network interface. The MME 3-25 may be connected to an eNB 3-30 that is an existing base station.

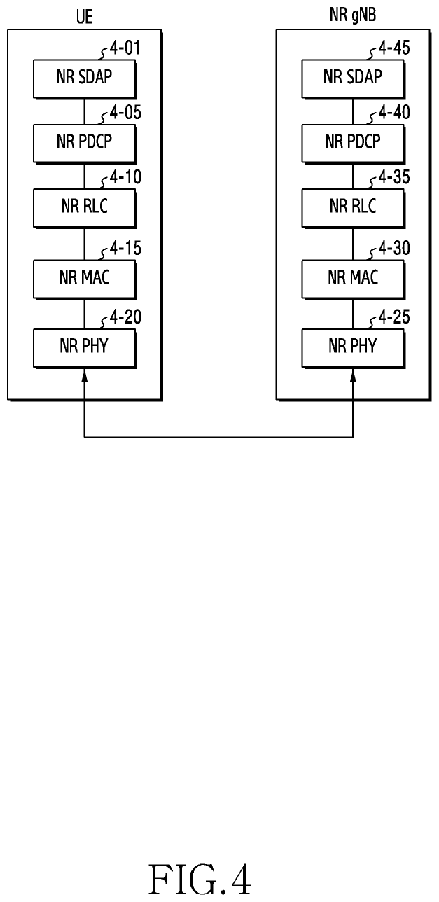

FIG. 4 illustrates a radio protocol structure of a next-generation mobile communication system according to an embodiment.

Referring to FIG. 4, a radio protocol of the next-generation mobile communication system may include an NR service data adaptation protocol (SDAP) layer 4-01 or 4-45, an NR PDCP layer 4-05 or 4-40, an NR RLC layer 4-10 or 4-35, an NR MAC layer 4-15 or 4-30, and an NR PHY layer 4-20 or 4-25 on each of UE and NR base station sides. The radio protocol of the next-generation mobile communication system may also include a larger or smaller number of layers than those of the structure illustrated in FIG. 4.

According to an embodiment of the disclosure, example functions of the NR SDAP 4-01 or 4-45 may include:
Transfer of user plane data
Mapping between a QoS flow and a data radio bearer (DRB) for both DL and UL
Marking QoS flow ID in both DL and UL packets
Reflective QoS flow to DRB mapping for the UL SDAP PDUs

With regard to the SDAP device (which may be interchangeably used with layer or layer device) 4-01 or 4-45, the UE may be configured, through an RRC message, whether to use the header of the SDAP layer device with regard to each PDCP layer device or with regard to each bearer or with regard to each logical channel, or whether to use functions of the SDAP device 4-01 or 4-45. If an SDAP header is configured, a non-access stratum (NAS) QoS reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the UL and DL. According to an embodiment, the SDAP header may include QoS flow ID information indicating the QoS. Furthermore, according to an embodiment, the QoS information may be used as data processing priority, scheduling information, etc., for smoothly supporting services.

According to an embodiment of the disclosure, example functions of the NR PDCP 4-05 or 4-40 may include:
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in UL

Among the above-described functions, the reordering of the NR PDCP device 4-05 or 4-40 may refer to a function of reordering PDCP PDU received from a lower layer in an order based on PDCP sequence numbers. The reordering of the NR PDCP device 4-05 or 4-40 may include at least one of a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

According to an embodiment of the disclosure, example, functions of the NR RLC 4-10 or 4-35 may include:
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

According to an embodiment of the disclosure, the in-sequence delivery of the NR RLC device 4-10 or 4-35 may refer to a function of successively delivering RLC SDUs received from the lower layer to the upper layer. The in-sequence delivery of the NR RLC device may include a function of, if one original RLC SDU is segmented into multiple RLC SDUs and the segmented RLC SDUs are received, reassembling the RLC SDUs and delivering the reassembled RLC SDUs.

The in-sequence delivery of the NR RLC device 4-10 or 4-35 may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number or PDCP sequence number, a function of recording RLC PDUs lost as a result of reordering, a function of reporting the state of the lost RLC PDUs to the transmitting side, and a function of requesting retransmission of the lost RLC PDUs.

According to an embodiment of the disclosure, the in-sequence delivery of the NR RLC 4-10 or 4-35 may include at least one of a function of, if there is a lost RLC SDU, sequentially transferring only RLC SDUs before the lost RLC SDU to an upper layer, a function of, although there is a lost RLC SDU, if a predetermined timer has expired, sequentially transferring, to an upper layer, all the RLC SDUs received before the timer is started, and a function of, although there is a lost RLC SDU, if a predetermined timer has expired, sequentially transferring all the RLC SDUs received up to now, to an upper layer.

The in-sequence delivery of the NR RLC device 4-10 or 4-35 may include a function of, although there is a lost RLC SDU, if a predetermined timer has expired, sequentially transferring, to the upper layer, all the RLC SDUs received before the timer is started.

The in-sequence delivery of the NR RLC device 4-10 or 4-35 may include a function of, although there is a lost RLC SDU, if a predetermined timer has expired, sequentially transferring all the RLC SDUs received up to the current, to an upper layer.

The NR RLC device 4-10 or 4-35 may process RLC PDUs in a reception sequence, regardless of a sequence based on sequence numbers (out-of-sequence delivery) and then deliver the processed RLC PDUs to the NR PDCP device 4-05 or 4-40.

According to an embodiment of the disclosure, if receiving segments, the NR RLC device 4-10 or 4-35 may receive segments stored in a buffer or to be received in the future, reconfigure the segments into one whole RLC PDU, process the RLC PDU, and then deliver the processed RLC PDU to the NR PDCP device 4-05 or 4-40.

According to an embodiment of the disclosure, the NR RLC device 4-10 or 4-35 may include no concatenation function, which may be performed in the NR MAC layer or replaced with a multiplexing function of the NR MAC layer.

The above-mentioned out-of-sequence delivery of the NR RLC device 4-10 or 4-35 may refer to a function of instantly delivering RLC SDUs received from the lower layer to the upper layer regardless of the order. The out-sequence delivery of the NR RLC device 4-10 or 4-35 may include a function of, if one original RLC SDU is segmented into multiple RLC SDUs and the segmented RLC SDUs are received, reassembling the RLC SDUs and delivering the reassembled RLC SDUs. Furthermore, the out-of-sequence delivery function of the NR RLC device 4-10 or 4-35 may include a function of storing an RLC sequence number or a PDCP sequence number of received RLC PDUs and arranging order to record lost RLC PDUs.

According to an embodiment of the disclosure, the NR MAC device 4-15 or 4-30 may be connected to multiple NR RLC layer devices configured in one UE, and example functions of the NR MAC 4-15 or 4-30 may include:
Mapping between logical channels and transport channels
Multiplexing/demultiplexing of MAC SDUs
Scheduling information reporting
Error correction through HARQ
Priority handling between logical channels of one UE
Priority handling between UEs via dynamic scheduling
MBMS service identification
Transport format selection
Padding

According to an embodiment of the disclosure, the NR PHY layer 4-20 or 4-35 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

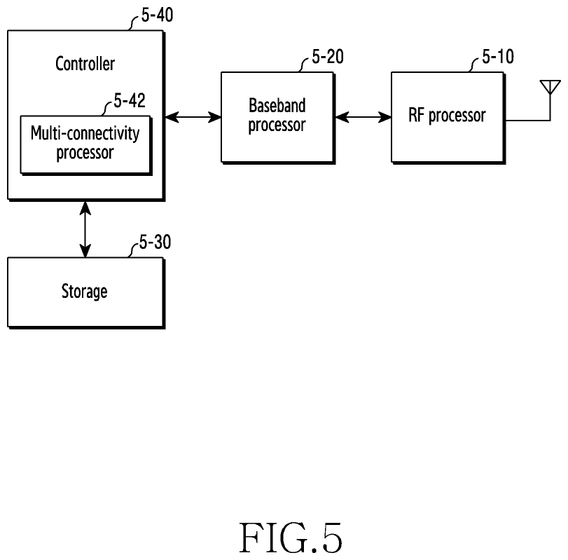

FIG. 5 illustrates a UE according to an embodiment.

Referring to FIG. 5, the UE may include a radio frequency (RF) processor 5-10, a baseband processor 5-20, a storage 5-30, and a controller 5-40. However, the example given in FIG. 5 is not limiting, and the UE may include a smaller or larger number of components than illustrated in FIG. 5.

The RF processor 5-10 may perform a function for transmitting and receiving a signal via a wireless channel, such as band conversion and amplification of the signal. That is, the RF processor 5-10 may up-convert a baseband signal provided from the baseband processor 5-20 to an RF band signal, may transmit the same through an antenna, and may down-convert an RF band signal received through the antenna to a baseband signal. For example, the RF processor 5-10 may include a transmission filter, a reception filter, an amplifier, a mixer, an oscillator, a digital-to-analog converter (DAC), an analog-to-digital converter (ADC), etc. Although only one antenna is illustrated in FIG. 5, the UE may include multiple antennas. In addition, the RF processor 5-10 may include multiple RF chains.

Furthermore, the RF processor 5-10 may perform beamforming. For beamforming, the RF processor 5-10 may adjust the phase and magnitude of each of signals transmitted and received through multiple antennas or antenna elements. In addition, the RF processor 5-10 may perform MIMO, and may receive multiple layers when performing MIMO operations. The RF processor 5-10 may appropriately configure multiple antennas or antenna elements to perform reception beam sweeping or may adjust the direction and beam width of a reception beam so as to resonate the reception beam with a transmission beam under the control of the controller.

The baseband processor 5-20 may perform functions of conversion between baseband signals and bitstrings according to the system's physical layer specifications. For example, during data transmission, the baseband processor 5-20 may encode and modulate a transmitted bitstring to generate complex symbols. In addition, during data reception, the baseband processor 5-20 may demodulate and decode a baseband signal provided from the RF processor 5-10 to restore a received bitstring. For example, when following the OFDM scheme, during data transmission, the baseband processor 5-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 5-20 may split a baseband signal provided from the RF processor 5-10 at the OFDM symbol level, may restore signals mapped to subcarriers through a fast Fourier transform (FFT) operation, and may restore a received bitstring through demodulation and decoding.

According to an embodiment of the disclosure, the baseband processor 5-20 and the RF processor 5-10 may transmit and/or receive a signal as described above. Therefore, the baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different RATs. In addition, at least one of the baseband processor 5-20 and the RF processor 5-10 may include different communication modules to process signals in different frequency bands. For example, the different RATs may include a wireless local area network (LAN) (e.g., IEEE 802.11), a cellular network (e.g., LTE), etc. In addition, the different frequency bands may include super high frequency (SHF) (e.g., 2 NRHz) bands and mmWave (e.g., 60 GHz) bands. The UE may transmit/receive a signal with the base station by using the baseband processor 5-20 and the RF processor 5-10, and the signal may include control information and data.

The storage 5-30 may store basic programs, application programs, and data, such as configuration information, for operation of the main base station. Particularly, the storage 5-30 may store information regarding a second access node configured to perform wireless communication by using a second RAT. In addition, the storage 5-30 provides the stored data at the request of the controller 5-40. In addition, the storage 5-30 may be configured by multiple memories. According to an embodiment, the storage 5-30 may store programs for performing the conditional PSCell change method set forth herein.

According to an embodiment of the disclosure, the controller 5-40 may control the overall operation of the UE. For example, the controller 5-40 may transmit/receive signals through the baseband processor 5-20 and the RF processor 5-10. In addition, the controller 5-40 records data in the storage 5-30 and reads the data from the storage 5-30. To this end, the controller 5-40 may include at least one processor. For example, the controller 5-40 may include a communication processor configured to perform control for communication, and an application processor (AP) configured to control upper layers such as application programs. In addition, at least one component in the UE may be implemented as a single chip. Furthermore, according to an embodiment of the disclosure, the controller 5-40 may include a multi-connectivity processor 5-42 which performs processing for operating in a multi-connectivity mode.

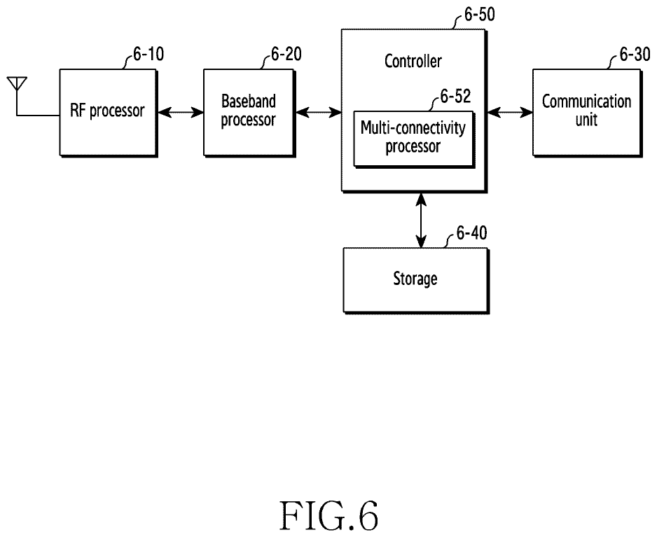

FIG. 6 illustrates an NR base station according to an embodiment.

Referring to FIG. 6, the base station includes an RF processor 6-10, a baseband processor 6-20, a backhaul communication unit 6-30, a storage 6-40, and a controller 6-50. However, the example given in FIG. 6 is not limiting, and the base station may include a smaller or larger number of components than illustrated in FIG. 6.

According to an embodiment, the RF processor 6-10 may perform functions for transmitting/receiving signals through a radio channel, such as signal band conversion and amplification. That is, the RF processor 6-10 may up-convert a baseband signal provided from the baseband processor 6-20 to an RF band signal, may transmit the same through an antenna, and may down-convert an RF band signal received through the antenna to a baseband signal. For example, the RF processor 6-10 may include a transmission filter, a reception filter, an amplifier, a mixer, an oscillator, a DAC, and an ADC. Although only one antenna is illustrated in FIG. 6, the base station may include multiple antennas. In addition, the RF processor 6-10 may include multiple RF chains. Furthermore, the RF processor 6-10 may perform beamforming. For the beamforming, the RF processor 6-10 may adjust the phase and magnitude of each of signals transmitted and received through multiple antennas or antenna elements. The RF processor 6-10 may transmit one or more layers to perform a downward MIMO operation.

According to an embodiment, the baseband processor 6-20 may perform a function of conversion between a baseband signal and a bitstream according to a physical layer specification of a first wireless access technology. For example, during data transmission, the baseband processor 6-20 may encode and modulate a transmitted bitstring to generate complex symbols. In addition, during data reception, the baseband processor 6-20 may demodulate and decode a baseband signal provided from the RF processor 6-10 to restore a received bitstring. For example, when following the OFDM scheme, during data transmission, the baseband processor 6-20 may encode and modulate a transmitted bitstring to generate complex symbols, may map the complex symbols to subcarriers, and may configure OFDM symbols through an IFFT operation and CP insertion. In addition, during data reception, the baseband processor 6-20 may split a baseband signal provided from the RF processor 6-10 at the OFDM symbol level, may restore signals mapped to subcarriers through FFT operation, and may restore a received bitstring through demodulation and decoding. The baseband processor 6-20 and the RF processor 6-10 may transmit and receive signals as described above. Therefore, the baseband processor 6-20 and the RF processor 6-10 may be referred to as a transmitter, a receiver, a transceiver, a communication unit, or a wireless communication unit.

According to an embodiment of the disclosure, the backhaul communication unit 6-30 may provide an interface for communicating with other nodes in the network. That is, the backhaul communication unit 6-30 may convert bitstrings transmitted from the main base station to other nodes (e.g., auxiliary base station, CN) into physical signals, and may convert physical signals received from the other nodes into bitstrings.

The storage 6-40 may store basic programs, application programs, and data, such as configuration information, for operation of the main base station. In particular, the storage 6-40 may store information on bearers allocated to the connected UE, measurement results reported from the connected UE, etc. In addition, the storage 6-40 may store information serving as a reference to determine whether to provide multi-connectivity to a UE or to suspend the same. In addition, the storage 6-40 may provide the stored data at the request of the controller 6-50. In addition, the storage 6-40 may provide the stored data at the request of the controller 6-50. The storage 6-40 may be configured by a storage media such as a read only memory (ROM), a random access memory (RAM), a hard disk, a compact disc (CD)-ROM, a digital versatile disc (DVD), or a combination of storage media. In addition, the storage 6-40 may be configured by multiple memories. According to an embodiment, the storage 6-40 may store programs for performing the conditional PSCell change method set forth herein.

The controller 6-50 may control the overall operation of the base station. For example, the controller 6-50 may transmit/receive signals through the baseband processor 6-20 and the RF processor 6-10 or through the backhaul communication unit 6-30. In addition, the controller 6-50 records data in the storage 6-40 and reads the data from the storage 6-40. To this end, the controller 6-50 may include at least one processor. In addition, at least one component of the base station may be implemented as a single chip. In addition, according to an embodiment of the disclosure, the controller 6-50 may include a multi-connectivity processor 6-52 configured to perform processing for operating in a multi-connectivity mode. The controller 6-50 may control the operations of the base station or an entity corresponding thereto according to various embodiments of the disclosure.

In discussions regarding 3GPP RAN2#127bis, L1/2 triggered mobility (LTM) or lower-layer triggered mobility is about a condition type of a conditional LTM (CLTM) and a distributed unit (DU) needing to make a CLTM condition type. Release 19 CLTM has been determined to be configured only within an intra-CU. Instead, an LTM may be configured in an inter-CU.

A problem to be solved in the disclosure may relate to a case in which an LTM and a CLTM are configured for a UE at the same time.

Regardless of a target cell of a CLTM or a target cell of an LTM, when there is no particular reason, most target cells may be highly likely to be configured the same. Therefore, when an LTM cell or a CLTM cell performs mobility, a case in which the same target cell configuration is used may be considered. Based on this assumption, a proposed operation is provided.

When a network forwards a CLTM configuration to a UE, the UE may store the configuration. The UE may perform measurement and evaluation through condition information indicated for each CLTM candidate cell, and may apply a target cell configuration of a CLTM candidate cell associated with a condition to perform a cell change when the condition is satisfied.

To this end, the network may forward a CLTM configuration including at least one of the following pieces of information to the UE.

Set of beams considered as measurement targets in CLTM candidate cells: LTM-CSI-ResourceConfig list

At least one of the following pieces of information for each CLTM candidate cell:
Target cell configuration
Initial execution condition
Subsequent execution condition

In an existing CLTM, when receiving the forgoing information, the UE may perform measurement and condition evaluation on a CLTM candidate cell. The UE may execute the CLTM when a condition is satisfied. The UE may evaluate a condition required for the CLTM for each switchable candidate cell with a current serving cell as a source, and the condition required for the CLTM may be referred to as initial condition execution condition. However, for CLTM candidate cells, the UE may need to update UE measurement and evaluation conditions by using a condition (e.g., a subsequent condition) required when moving from a cell to another CLTM candidate cell, after moving to the cell. Here, the condition for updating the UE measurement and evaluation conditions may be a subsequent condition, and the UE may need to perform an operation of updating/replacing an initial condition in each target cell with a part or all of a subsequent condition in the target cell, after a CLTM movement to the target cell.

However, in an embodiment of the disclosure, even though the UE performs measurement and condition evaluation after receiving the configuration, the UE may receive a cell switch command from the network. Here, even though an ID of an indicated target cell is a candidate cell ID of the CLTM or a candidate cell of the CLTM, the UE may move to the cell. For example, when the network transmits a cell switch command to a cell without the UE autonomously evaluating a condition, the UE may execute an LTM to the cell. In this case, the cell switch command may be transmitted including a timing advance (TA) value. When the TA value exists, the UE may perform UL transmission (including a random access channel (RACH) process) in the target cell by using the indicated TA value. When no TA value is indicated in the cell switch command, if a TA value is previously indicated and is valid based on a timer, the UE may use the indicated TA value. When no TA value is indicated in the cell switch command and the previously given TA value is not valid based on a timer value, the UE may execute a RACH-based CLTM with respect to the candidate cell.

For a cell ID indicated by the cell switch command, when the network includes LTM and CLTM configurations in one field, allocates the same candidate cell ID to the same candidate cell among candidate cells (e.g., for one cell, only one ID may exist in one field), and uses the same target cell configuration, the UE may perform a cell switch to a cell corresponding to the ID indicated by the cell switch command regardless of whether condition evaluation is applied or not, i.e., regardless of whether the cell is an LTM candidate or a CLTM candidate. When the network configures separate fields for LTM and CLTM candidate cells, the cell switch command may be transmitted including an indicator indicating whether a candidate cell is an LTM or a CLTM along with a candidate cell ID.

Alternatively, when the network uses a CLTM-dedicated cell switch MAC CE, only a candidate cell ID may be indicated. The UE may move by applying an LTM or CLTM candidate (cell) configuration with reference to an indicator or message for the candidate cell ID.

When the network configures separate fields for the LTM and the CLTM, if a candidate cell ID is uniquely allocated regardless of the LTM/CLTM, the UE may move by applying a candidate cell configuration indicated by the candidate cell ID of the cell switch command regardless of the LTM/CLTM.

For the foregoing operation, the network may perform an L1 event triggered report or general CSI report configuration in LTM-CSI-ResourceConfig associated with LTM-CSI-ReportConfig ID indicated in the current serving cell for each CLTM candidate cell, and may receive an L1 measurement result report. Further, the network may include a separate ID using LTM-CSI-ReportConfig that links condition information including an event type of the CLTM with respect to the same LTM-CSI-ResourceConfig in CSI-measConfig. Since one ID is a configuration for reporting and another ID is information for executing the CLTM for the same measurement target, the network may receive a report, and may also perform a CLTM condition determination operation. When the network receives a report, the network may command a cell switch with respect to a candidate cell being under CLTM condition determination according to the type of the report.

The CLTM configuration may assume a subsequent operation between CLTM configuration candidate cells, and may be divided into information included in CLTM-config and used throughout the subsequent operation and information reconfigured when a cell is changed through single CLTM execution. For example, the information included in CLTM-config and used throughout the subsequent operation may include an ID of each CLTM candidate cell, a target cell configuration of each candidate cell, and a subsequent execution condition of each candidate cell.

The latter information (information to be reconfigured when a cell is changed through single CLTM execution) may be an initial execution condition based on the current serving cell.

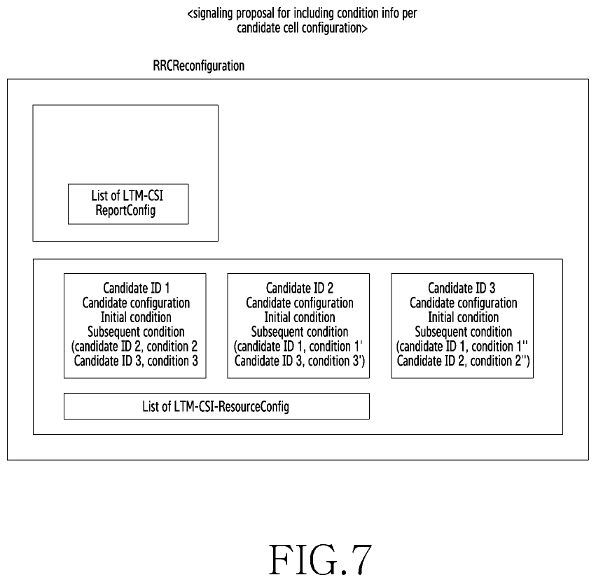

FIG. 7 illustrates an example of an initial condition and a subsequent execution condition being indicated together in a CLTM target cell configuration in a wireless communication system according to an embodiment.

Referring to FIG. 7, assuming a case of operating in an intra-CU, when a UE moves to a CLTM candidate cell after executing a CLTM, an operation of updating an initial execution condition may be needed. However, the UE may not perform an operation of deleting the entire CLTM configuration.

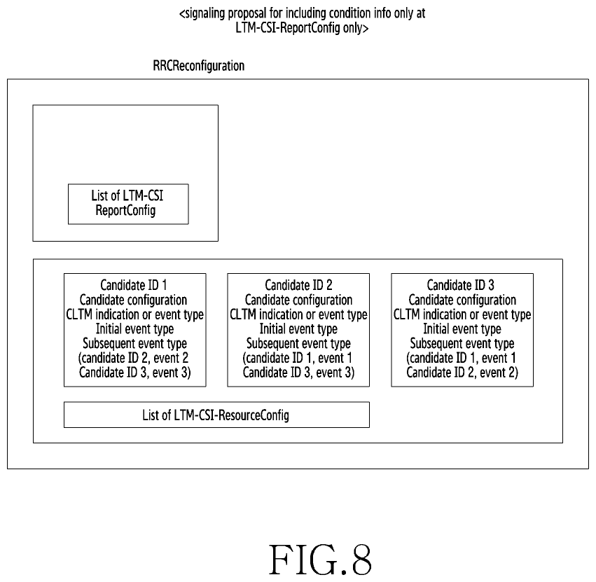

FIG. 8 illustrates an example of an initial condition and a subsequent execution condition being included in LTM-CSI-ReportConfig in a wireless communication system according to an embodiment.

Referring to FIG. 8, assuming a case of operating in an intra-CU, a CLTM indicator or an event type of a CLTM condition may be indicated for each candidate cell. In a case of transmitting the CLTM indicator, a UE may not have a separate initial condition update operation after executing a CLTM. In a case of indicating the event type information for the CLTM condition, an initial condition update operation may be needed, similar to the case of FIG. 7. However, in both cases, the UE may not perform an operation of deleting the entire CLTM configuration.

Regarding a CLTM initial condition update operation and an operation of maintaining or deleting the entire CLTM configuration, example operations of the UE in the following situations may include:
1. When a CLTM is (successfully) executed or when an LTM to a CLTM candidate cell is indicated by a network and succeeds
A. The UE may need to update CLTM initial condition-related information.
B. The UE may not release LTM-config.
C. The UE may not release the CLTM configuration.
2. When an LTM from a CLTM cell to a non-CLTM intra-CU or inter-CU LTM cell is indicated and succeeds, when the UE successfully moves to the non-CLTM intra-CU or inter-CU LTM cell upon indication of a general secondary cell (SCell) change or primary cell (PCell) handover, or when the UE successfully moves to the non-CLTM intra-CU or inter-CU LTM cell through a conditional handover A. The CLTM configuration may be released (option 1), or may be deactivated or suspended (option 2).

i. Option 1: The UE may release the CLTM configuration (option 1-1). Alternatively, the UE may release pieces of condition information about all candidate cells (e.g., an initial condition for each candidate cell and a subsequent condition associated with the cells) of the CLTM configuration (option 1-2).
1. Accordingly, when executing an LTM from the intra-CU LTM cell or the inter-CU LTM cell back to the existing CLTM cell, the network may indicate the entire CLTM configuration to the UE again (option 1-1). Alternatively, with respect to the CLTM candidate cells, the network may indicate the initial condition of each candidate cell and/or the pieces of subsequent condition information about each candidate cell to the UE again.
2. The entire CLTM configuration or the pieces of condition information may be reconfigured by the network after the UE moves to a CLTM candidate cell, or may be reconfigured simultaneously while the UE include the same in a target cell configuration of the CLTM candidate cell and moves to the candidate cell before moving to the CLTM candidate cell.
ii. Option 2: The UE may deactivate or suspend the CLTM configuration or the initial condition and/or the subsequent condition thereof. Here, deactivation/suspension may include the entire CLTM configuration or configuration per each candidate cell being retained in a UE modem memory, although any operation for CLTM movement (e.g., measurement and/or condition determination based on the measurement) is not performed. To this end, the UE may internally and autonomously add an indicator corresponding to the pieces of deactivated or suspended information. For example, the UE may store an indicator indicating that the entire CLTM configuration or the pieces of condition information allocated to each CLTM candidate cells is deactivated together with the pieces of information.
1. Accordingly, when moving back to the existing CLTM cell from the intra-CU cell or inter-CU cell, the UE may activate or resume the deactivated or suspended CLTM configuration or the initial condition and/or subsequent condition thereof. Therefore, the UE may autonomously perform measurement for a condition and condition evaluation according to the CLTM configuration.
B. According to A, the UE may not update the CLTM-related initial condition information.
C. The UE may not release LTM-config.

When the UE being served in a CLTM cell moves to a non-CLTM cell (which is an LTM candidate cell), the UE should be able to identify that the target cell is an LTM cell (which is a non-CLTM cell) in order to perform a UE release or deactivation/suspension operation as in options 1 and 2. To this end, the following methods are provided.
Option 1: Using an integer ID associated with a CU

An integer ID associated with a CU serving each cell may be allocated in cell-specific configuration information about LTM and/or CLTM candidate cells and transmitted to the UE. The network may need to allocate the same ID to cells served by the same CU.

Subsequently, when an LTM cell switch is indicated or when a CLTM is executed, the UE receiving the information may compare an ID of a CU of the current cell (e.g., a source cell) and an ID of a CU associated with an ID of a candidate cell to which an LTM has been indicated. When the ID of the CU of the current cell and the ID of the CU associated with the ID of the candidate cell to which the LTM has been indicated are different, the UE may perform an operation of deleting or deactivating/suspending the CLTM configuration or CLTM condition information. When the ID of the CU of the current cell and the ID of the CU associated with the ID of the candidate cell to which the LTM has been indicated are the same, the UE may not perform the operation of deleting or deactivating/suspending the CLTM configuration or CLTM condition information.

When executing an LTM from the LTM (non-CLTM) cell to the previous CLTM cell, the UE may compare an ID of a CU of the current cell (e.g., a source cell), which is the LTM cell, and an ID of a CU of a candidate cell indicated by a cell switch command. When the ID of the CU of the LTM cell and the ID of the CU of the candidate cell indicated by the cell switch command are the same, the UE may not perform a separate release or deactivation/suspension operation. When the ID of the CU of the LTM cell and the ID of the CU of the candidate cell indicated by the cell switch command are different, the UE may perform the release or deactivation/suspension operation.

In this case, when the UE receives an indication of an LTM to an LTM cell in an intra-CU cell (e.g., a non-CLTM cell), it may be difficult to distinguish.

When the UE receives an indication of an LTM cell switch from the LTM to the CLTM cell after executing the release or deactivation/suspension operation by the foregoing method, the UE and the network may operate as follows. In a case of release (option 1), the network may include a CLTM configuration required by the network in target cell configuration information, or may forward the same to the UE through a separate RRCReconfiguration message after the UE moves to the target cell. In a case of deactivation/suspension (option 2), when a CLTM configuration (or condition information as a part of CLTM configurations) that is deactivated/suspended is present among the CLTM configurations currently stored in the memory of the UE, the UE may identify that a candidate cell indicated by a cell switch command in the candidate cell configurations is a deactivated/suspended candidate cell. Here, the UE may reactivate/resume configurations of all deactivated/suspended CLTM candidate cells. In this case, identification and/or determination may be performed by comparing LTM candidate cell IDs, previously transmitted physical cell ID (PCI) values per candidate cell, or combinations of target cell PCIs and frequency information in reconfiguration-with-sync fields in special cell (Spcell) configurations in target cell configurations previously transmitted per candidate cell.
Option 2: The network may indicate a candidate cell ID through a separate indicator in a cell switch command.

The network may know whether a target cell to be indicated by the network belongs to the same CU as a current source cell. Therefore, when reporting a candidate cell ID through an LTM cell switch command, the network may include a 1-bit indicator regarding whether to perform release or deactivation/suspension. Upon receiving the cell switch command, the UE may release or deactivate/suspend a CLTM configuration/pieces of condition information according to the 1-bit indicator.

When the UE receives an indication of an LTM cell switch from the LTM to the CLTM cell after executing the release or deactivation/suspension operation by the foregoing method, the UE and the network may operate as follows. In a case of release (option 1), the network may include a CLTM configuration required by the network in target cell configuration information, or may forward the same to the UE through a separate RRCReconfiguration message after the UE moves to the target cell. In a case of deactivation/suspension (option 2), when a CLTM configuration (or condition information as a part of CLTM configurations) that is deactivated/suspended is present among the CLTM configurations currently stored in the memory of the UE, the UE may identify that a candidate cell indicated by a cell switch command in the candidate cell configurations is a deactivated/suspended candidate cell. The UE may reactivate/resume configurations of all deactivated/suspended CLTM candidate cells. In this case, identification and/or determination may be performed by comparing LTM candidate cell IDs, previously transmitted PCI values per candidate cell, or combinations of target cell PCIs and frequency information in reconfiguration-with-sync fields in Spcell configurations in target cell configurations previously transmitted per candidate cell.
Option 3: A CLTM candidate ID and/or presence of condition information given for a CLTM candidate cell may be used.

When the UE receives a CLTM configuration, each candidate cell ID may be configured as a unique ID for a single cell regardless of an LTM and a CLTM (case 1). Alternatively, the CLTM may be configured in a field separated from the LTM (case 2). When the UE moves from a source cell which is a CLTM cell to an LTM cell which is a non-CLTM cell, if the target cell of an LTM indication has condition information in case 1 and case 2, the UE may recognize that the cell is a CLTM candidate cell. However, when there is no condition information, the UE may identify that the cell is a non-CLTM cell and LTM cell. Accordingly, when the target is a non-CLTM through presence of the condition information, the UE may perform a release or deactivation/suspension operation. The presence of the condition information may be explicitly indicated in a candidate cell-specific configuration in LTM-config or CLTM-config. Alternatively, the presence of the condition information may be determined by presence of a CLTM event type included in LTM-CSI-ReportConfig in CSI-measConfig of a serving cell configuration of a candidate cell.

When the UE receives an indication of an LTM cell switch from the LTM to the CLTM cell after executing the release or deactivation/suspension operation by the foregoing method, the UE and the network may operate as follows.

In a case of release (option 1), the network may include a CLTM configuration required by the network in target cell configuration information, or may forward the same to the UE through a separate RRCReconfiguration message after the UE moves to the target cell.

In a case of deactivation/suspension (option 2), when a CLTM configuration (or condition information as a part of CLTM configurations) that is deactivated/suspended is present among the CLTM configurations currently stored in the memory of the UE, the UE may identify that a candidate cell indicated by a cell switch command in the candidate cell configurations is a deactivated/suspended candidate cell. The UE may reactivate/resume configurations of all deactivated/suspended CLTM candidate cells. In this case, identification and/or determination may be performed by comparing LTM candidate cell IDs, previously transmitted PCI values per candidate cell, or combinations of target cell PCIs and frequency information in reconfiguration-with-sync fields in Spcell configurations in target cell configurations previously transmitted per candidate cell.

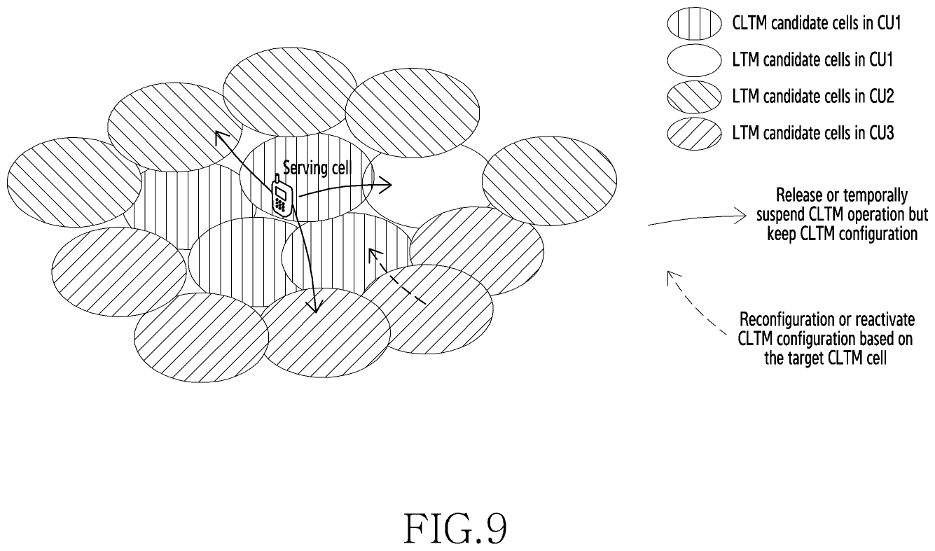

FIG. 9 illustrates movement between a CLTM cell and an LTM cell in a wireless communication system according to an embodiment.

Referring to FIG. 9, when moving from a CLTM cell to an LTM cell that is a non-CLTM cell, a UE may perform an operation of releasing or suspending a CLTM configuration or condition information of the CLTM configuration. Basically, the CLTM configuration is valid only for a cell in a single CU, and when the UE moves to an LTM cell of a different CU, the UE may perform the release/suspension operation. When the UE moves from the LTM cell back to the CLTM cell in a state in which the release/suspension operation has been performed, the UE may reconfigure or reactivate the CLTM configuration or condition information.

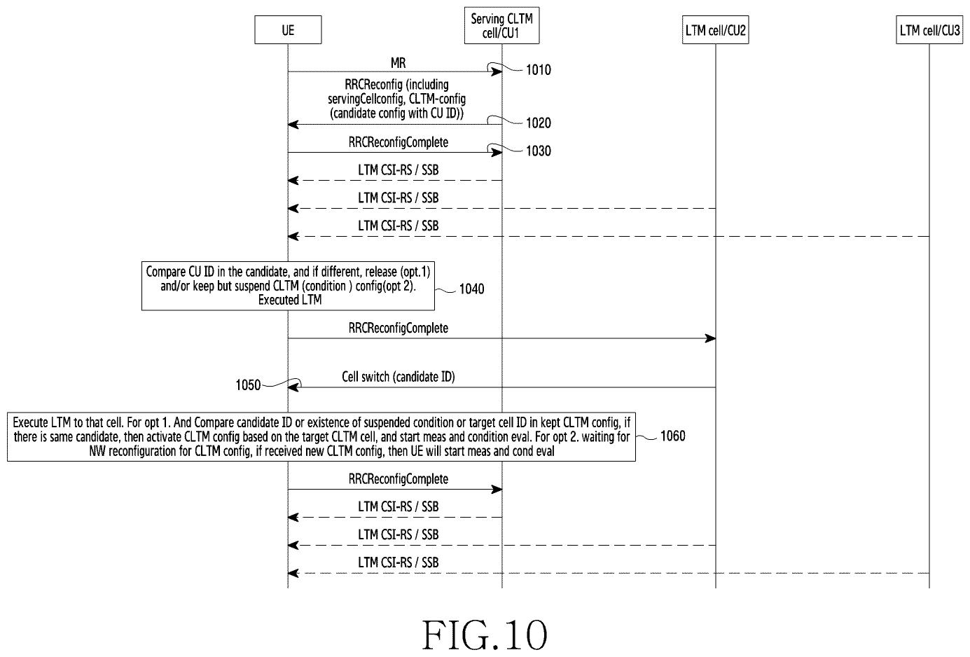

FIG. 10 is a signal flow diagram illustrating a deactivation/suspension operation performed with a CU ID in a wireless communication system according to an embodiment.

Referring to FIG. 10, in operation 1010, a UE may transmit a measurement report (MR) to a network. In operation 1020, A serving cell may transmit an RRCReconfiguration message including a CLTM and/or LTM configuration to the UE, based on the MR.

The CLTM and/or LTM configuration included in the MR message may include an integer ID allocated for each CU in each candidate cell configuration.

In operation 1030, the UE may transmit an RRCReconfigComplete message to the serving cell.

In operation 1040, the UE having stored the foregoing information may receive an indication of executing an LTM to a non-CLTM cell, which may be performed through a cell switch MAC CE. The cell switch MAC CE may include a candidate cell ID. The UE may execute the LTM to the cell, and may identify the CU ID of the candidate cell included in the LTM configuration. The UE may compare the CU ID of the candidate cell included in the LTM configuration and a CU ID in a candidate cell configuration of a current source cell, and may release or deactivate/suspend the CLTM configuration or CLTM condition information when the CU IDs are different.

In operations 1050 and 1060, when the UE receives an indication of an LTM to the previous CLTM cell from the network after moving to the cell, if there is a currently suspended CLTM configuration, the UE may identify whether the indicated target cell is a cell existing in the existing suspended CLTM configuration. The operation may follow the methods of options 1, 2, and 3 described above.

When the CLTM configuration is reactivated, the UE may perform a measurement operation for a condition and a condition evaluation operation.

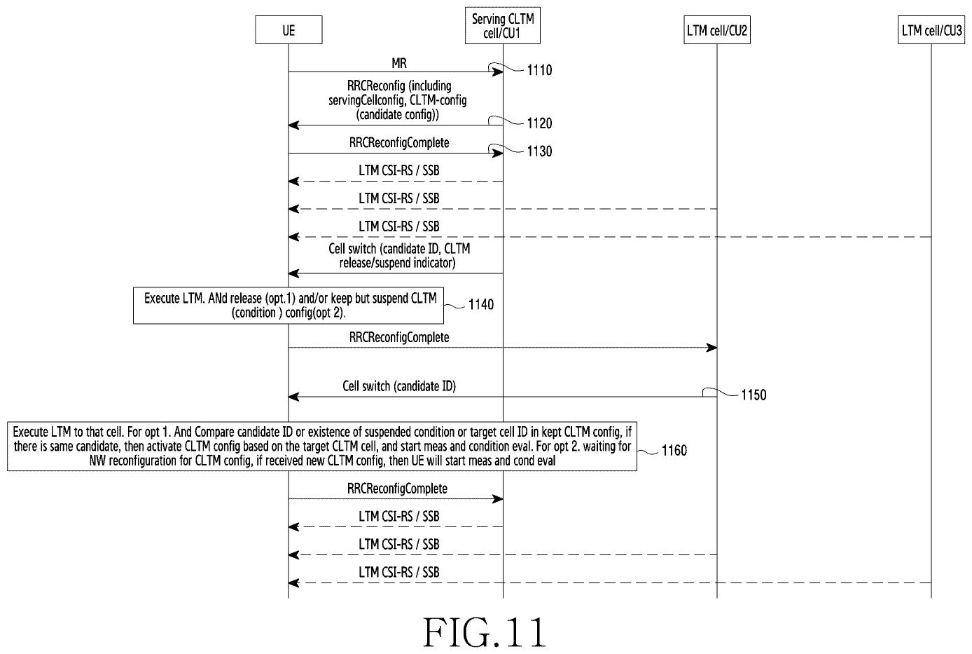

FIG. 11 is a signal flow diagram illustrating a deactivation/suspension operation performed by a network indication in a wireless communication system according to an embodiment.

Referring to FIG. 11, in operation 1110, a UE may transmit a MR to a network. A serving cell may transmit an RRCReconfiguration message including a CLTM and/or LTM configuration to the UE, based on the MR.

In operation 1120, the CLTM and/or LTM configuration included in the RRCReconfiguration message may include an integer ID allocated for each CU in each candidate cell configuration.

In operation 1130, the UE may transmit an RRCReconfigComplete message to the serving cell.

In operation 1140, the UE having stored the foregoing information may receive an indication of executing an LTM to a non-CLTM cell. The LTM to the non-CLTM cell may be executed through a cell switch MAC CE, and the cell switch MAC CE may include a candidate cell ID. Further, the cell switch MAC CE may include an indicator indicating whether to release or suspend a CLTM. When receiving the cell switch MAC CE, the UE may execute the LTM to the non-CLTM cell, and may release or suspend the CLTM configuration or condition information of the CLTM configuration according to the indicator.

In operations 1150 and 1160, when the UE receives an indication of an LTM to the previous CLTM cell from the network after moving to the cell (e.g., the non-CLTM cell), if there is a currently suspended CLTM configuration, the UE may identify whether the indicated target cell is a cell existing in the existing suspended CLTM configuration. The operation may follow the methods of options 1, 2, and 3 described above.

When the CLTM configuration is reactivated, the UE may perform a measurement operation for a condition and a condition evaluation operation.

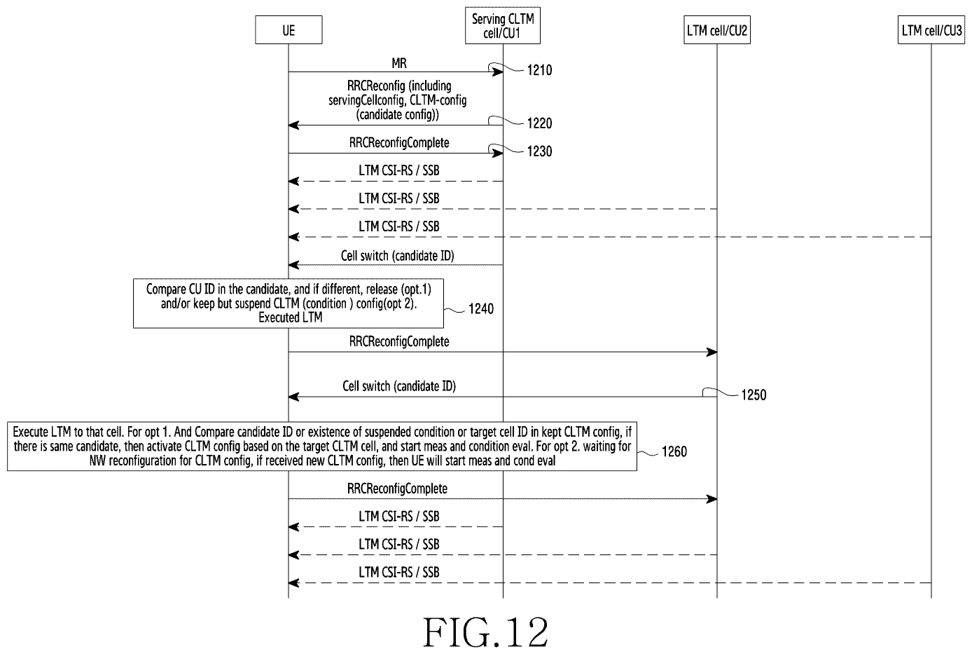

FIG. 12 is a signal flow diagram illustrating use of a CLTM candidate ID and/or whether CLTM condition information exists in a wireless communication system according to an embodiment.

Referring to FIG. 12, in operation 1210, a UE may transmit a MR to a network. A serving cell may transmit an RRCReconfiguration message including a CLTM and/or LTM configuration to the UE, based on the MR.

In operation 1220, The CLTM and/or LTM configuration included in the RRCReconfiguration message may include an integer ID allocated for each CU in each candidate cell configuration.

In operation 1230, The UE may transmit an RRCReconfigComplete message to the serving cell.

In operation 1240, The UE having stored the foregoing information may receive an indication of executing an LTM to a non-CLTM cell. The LTM to the non-CLTM cell may be executed through a cell switch MAC CE. The UE may identify a candidate ID of the indicated target cell, and may identify whether the indicated target cell is a CLTM candidate cell by using a candidate cell ID (e.g., when candidate cells are configured in a separate CLTM-config field and indicated to the UE but an ID for a single cell is uniquely allocated regardless of an LTM or a CLTM), or may identify whether condition information is associated with the candidate cell. When the target cell is a candidate cell only for an LTM or when no condition information is associated with the target cell, the UE may perform the LTM to the target cell. In addition, the UE may release or suspend the CLTM configuration or condition information of the CLTM configuration.

In operations 1250 and 1260, When the UE receives an indication of an LTM to the previous CLTM cell from the network after moving to the cell (e.g., the non-CLTM cell), if there is a currently suspended CLTM configuration, the UE may identify whether the indicated target cell is a cell existing in the existing suspended CLTM configuration. The operation may follow the methods of options 1, 2, and 3 described above.

When the CLTM configuration is reactivated, the UE may perform a measurement operation for a condition and a condition evaluation operation.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a RAM and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, LAN, wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on a frequency division duplex (FDD) LTE system, other variants based on the technical idea of the embodiments may also be implemented in other communication systems such as time division duplex (TDD) LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a wireless communication system, the method comprising:
receiving, from a base station, configuration information on a layer 1/layer 2 (L1/L2) triggered mobility (LTM) including an execution condition for an LTM cell switch; and
performing an evaluation for the execution condition of the LTM cell switch based on the configuration information, after the LTM cell switch.

2. The method of claim 1, wherein the execution condition for the LTM cell switch includes a first execution condition associated with a serving cell and a second execution condition for at least one LTM candidate.

3. The method of claim 2, wherein the configuration information on the LTM further includes information for configuring the at least one LTM candidate.

4. The method of claim 2, wherein the configuration information is associated with an identifier (ID) of the at least one LTM candidate.

5. The method of claim 2, wherein the first execution condition is for an initial LTM cell switch of the serving cell, and
wherein the second execution condition is for a subsequent LTM cell switch of the at least one LTM candidate.

6. A method performed by a base station in a wireless communication system, the method comprising:
transmitting, to a user equipment (UE), configuration information on a layer 1/layer 2 (L1/L2) triggered mobility (LTM) including an execution condition for an LTM cell switch,
wherein an evaluation for the execution condition of the LTM cell switch is based on the configuration information, after the LTM cell switch.

7. The method of claim 6, wherein the execution condition for the LTM cell switch includes a first execution condition associated with a serving cell and a second execution condition for at least one LTM candidate.

8. The method of claim 7, wherein the configuration information on the LTM further includes information for configuring the at least one LTM candidate.

9. The method of claim 7, wherein the configuration information is associated with an identifier (ID) of the at least one LTM candidate.

10. The method of claim 7, wherein the first execution condition is for an initial LTM cell switch of the serving cell, and
wherein the second execution condition is for a subsequent LTM cell switch of the at least one LTM candidate.

11. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, configuration information on a layer 1/layer 2 (L1/L2) triggered mobility (LTM) including an execution condition for an LTM cell switch, and
perform an evaluation for the execution condition of the LTM cell switch based on the configuration information, after the LTM cell switch.

12. The UE of claim 11, wherein the execution condition for the LTM cell switch includes a first execution condition associated with a serving cell and a second execution condition for at least one LTM candidate.

13. The UE of claim 12, wherein the configuration information on the LTM further includes information for configuring the at least one LTM candidate.

14. The UE of claim 12, wherein the configuration information is associated with an identifier (ID) of the at least one LTM candidate.

15. The UE of claim 12, wherein the first execution condition is for an initial LTM cell switch of the serving cell, and
wherein the second execution condition is for a subsequent LTM cell switch of the at least one LTM candidate.

16. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a user equipment (UE), configuration information on a layer 1/layer 2 (L1/L2) triggered mobility (LTM) including an execution condition for an LTM cell switch,
wherein an evaluation for the execution condition of the LTM cell switch is based on the configuration information, after the LTM cell switch.

17. The base station of claim 16, wherein the execution condition for the LTM cell switch includes a first execution condition associated with a serving cell and a second execution condition for at least one LTM candidate.

18. The base station of claim 17, wherein the configuration information on the LTM further includes information for configuring the at least one LTM candidate.

19. The base station of claim 17, wherein the configuration information is associated with an identifier (ID) of the at least one LTM candidate.

20. The base station of claim 17, wherein the first execution condition is for an initial LTM cell switch of the serving cell, and
wherein the second execution condition is for a subsequent LTM cell switch of the at least one LTM candidate.
